(19) United States
(12) Patent Application Publication
(10) Pub. No.: US 2021/0330119 A1
(43) Pub. Date: Oct. 28, 2021

(54) System and method for beverage dispensing

(71) Applicant: STARSHIP TECHNOLOGIES OÜ, Tallinn (EE)

(72) Inventors: Lauri VÄIN, Tallinn (EE); Antti MÄKELA, Helsinki (FI); Imre TERAS, Harjumaa (EE); Pasi NIKKANEN, Salo (FI)

(21) Appl. No.: 17/272,335

(22) PCT Filed: Sep. 4, 2019
(86) PCT No.: PCT/EP2019/073622

§ 371 Date: Feb. 28, 2021

(30) Foreign Application Priority Data
Sep. 7, 2018 (EP) 18193237.7

(51) Int. Cl. A47J 36/32; G07F 13/10; G05B 19/042; G05D 1/08; G05D 1/02

(52) U.S. Cl. CPC A47J 36/321; G07F 13/10; G05B 19/042; G05B 2219/2645; G05D 1/028; G05D 1/0225; G05D 1/0891

(57) ABSTRACT

The invention relates to a system and method for beverage dispensing. The system comprises a mobile robot and a beverage module fitted to it. The mobile robot comprises a motion component, a first processing component and a first communication component. The beverage module comprises at least one liquid container, at least one beverage dispenser, a second processing component, and a second communication component. The method comprises the mobile robot traveling to a first location, preparing a beverage, dispensing it and leaving the first location.

### FIELD

The invention relates to beverage dispensing. The invention further relates to mobile robots travelling to locations and dispensing beverages.

### INTRODUCTION

Vending machines for beverages are prevalent in both outdoor and indoor locations. It is convenient for customers to obtain a beverage on the go and potentially outside business hours. Beverage vending machines typically prepare a beverage by, at the very least, adding warm or hot water to it. Some vending machines prepare more elaborate beverages including milk, sugar, a specific brewing time and so on.

Recently, mobile robots have been used for transporting items in both outdoor and indoor environments. Such robots can also serve as mobile vending machines that can either roam on predetermined trajectories and/or be summoned by customers to specific locations. The customers often can communicate with such robots via different user interfaces.

For example, European patent EP 1 946 684 B1 discloses an autonomous mobile robotic device, comprising an integrated machine for producing beverages or liquid comestibles.

The robotic device is optimized for indoor navigation and the coffee machine is integrated into it.

Further developments are needed to provide reliable, efficient and convenient beverage dispensing via travelling mobile robots.

### SUMMARY

It is the object of the present invention to provide an improved, efficient and reliable way of dispensing beverages to individuals. It is also the object of the present invention to disclose mobile robots configured to dispense beverages. It is further the object of this invention to disclose on-demand and automatic beverage dispensing systems that are convenient to use.

In a first embodiment, a beverage dispensing system is disclosed. The beverage dispensing system comprises a mobile robot comprising a motion component, a first processing component and a first communication component. The beverage dispensing system further comprises a beverage module fitted to the mobile robot and comprising at least one liquid container, at least one beverage dispenser, a second processing component, and a second communication component.

The mobile robot can comprise, for example, a sidewalk delivery robot configured to travel around outdoor surroundings (such as cities, suburbs and/or smaller localities generally or substantially autonomously. Its motion component can preferably comprise wheels, such as four to eight wheels, preferably six wheels. The mobile robot can generally comprise a frame and a body with a space for the beverage module, preferably within the body.

The first processing and communication components can be integrated, for instance, as a system on a chip and/or a circuit board with means for communication. They can also be separate electronical components. The communication component can comprise a plurality of communication components and/or a single component configured to communicate via different communication protocol. This can advantageously be used as a failsafe in case one means of communication (or protocol) is unavailable or cannot be used for another reason. For example, the communication component can be configured to communicate via one or more of WLAN, Cellular networks, Bluetooth, NFC, Infrared and/or other protocols.

The beverage module can comprise an independent device configured to prepare and/or dispense a beverage. The beverage may already be pre-made and stored within the liquid container and/or the beverage may be made directly in the beverage module. For example, the liquid container can contain pre-brewed coffee, that can be kept warm either with passive means (e.g. insulation) and/or active means (e.g. heating pad). As another preferred embodiment, the beverage module can comprise the components to prepare coffee on the spot, i.e. coffee beans, milk, sugar, grinder, brewer, steamer and/or further components for preparing coffee. In this case, the liquid container can contain water. The beverage module can also comprise more than one liquid container, each comprising same or different liquids. For example, there could be two liquid containers: one with pre-brewed coffee and one with pre-steeped tea (and/or pre-made hot chocolate). Other liquids are also possible, for instance cooled beverages such as soft drinks, juices, and/or chilled tea/coffee.

The beverage dispenser can comprise a plurality of components configured to enable the transfer of the beverage from the liquid container to a beverage recipient.

In other words, the beverage dispensing system comprises a robot equipped with a beverage making and/or dispensing device. The system is particularly advantageous, since it allows for a mobile beverage dispensing device. In one example, the beverage dispensing system can be used as an on-demand beverage vending machine. That is, a user wishing to receive a beverage (for themselves or another person) may communicate with the system in order to set up a rendezvous point where the beverage is to be dispensed. Further, the beverage dispensing system allows for an efficient and convenient way of distributing beverages to beverage recipients, allowing for time, energy and resource optimization. Advantageously, the mobile robot may travel to various locations where beverages may be typically unavailable. For example, a user may request to receive a beverage in a park, near a bench they are sitting on. Furthermore, users with limited mobility might particularly benefit from the option to have a beverage delivered to them.

In some embodiments, the beverage module can be removably fitted to an opening within the mobile robot's body. That is, the beverage module can be placed within the mobile robot and removed from it easily and quickly. This can be useful if the beverage module requires maintenance, but the mobile robot does not, and it can simply be equipped with a different beverage module that is functional. Similarly, if a mobile robot requires maintenance, the beverage module can be simply moved to another mobile robot and continue to be used as part of the beverage dispensing system. Furthermore, if the beverage module requires refilling, it can be more energy and time efficient to simply replace the empty beverage module with a full one within the mobile robot, so that operations can continue immediately. The empty beverage module can then be refilled without time pressure. Even further, providing a self-sufficient and easily interchangeable beverage module allows the mobile robot to also quickly be reassigned to tasks other than dispensing beverages. For example, the beverage module can be removed from the mobile robot, and the resulting space can be used to store groceries and/or packages for delivery.

In some embodiments, the mobile robot can further comprise a lockable lid arranged so as to prevent access to the beverage module in a closed position and allow access to at least part of the beverage module in an open position. The lid can be configured to switch between the open and closed positions automatically, for example, upon command from the mobile robot's first processing component (and or upon outside command, e.g. from a remote server). The lid can be placed around the top of the mobile robot, and open to reveal a part of the beverage module. Most of the beverage module may be inaccessible to a beverage recipient, whether the lid is open or not. However, the lid may avoid tampering by third parties which are not authorized beverage recipients.

In some embodiments, the first communication component and the second communication component are configured to communicate with each other. In some such embodiments, the first communication component and the second communication component can be configured to exchange data related to preparing a beverage and dispensing it to a beverage recipient. This can be advantageous to coordinate beverage dispensing to a beverage recipient, and avoid, for example attempting to dispense a beverage while the mobile robot is travelling and/or its lid is closed.

In some such embodiments, the first processing component and the second processing component can be configured to coordinate providing a beverage to the beverage recipient via the first communication component and the second communication component. The coordination can comprise the first processing component ensuring that the motion component is not causing the robot to move and that the lockable lid is in the open position before the second processing component causes the beverage module to prepare a beverage and dispense it to a beverage recipient. Coordinating actions between the mobile robot and the beverage module can ensure smooth functioning of the beverage dispensing system and avoiding errors that can possibly lead to spills and/or malfunction of the system.

In some embodiments, the system can further comprise at least one inclination sensor. The inclination sensor can measure the slope of the surface that the mobile robot is resting on. Additionally or alternatively, the inclination sensor can measure any inclination of the mobile robot with respect to the ground as compared to standard operation. This inclination can be due, for example, to a defect of the motion component (such as, e.g. a flat tire) and/or to the unevenness of the surface itself (such as presence of potholes or small rocks). Then, prior to dispensing a beverage via the beverage module, at least one of the first processing component and the second processing component can determine the mobile robot's inclination based on data from the inclination sensor. The second processing component can be configured to abort beverage dispensing if the mobile robot's inclination does not fall within a predetermined range. The predetermined range can comprise, for instance, inclination of the ground above 5°, and/or above 10°. The range can also comprise inclination of the mobile robot with respect to the ground of about 5° or more. The inclination sensor can advantageously serve to prevent scenarios where beverage dispensing is hazardous due to possible tipping of the beverage and/or beverage cup during preparation and/or dispensing to a beverage recipient.

In some such embodiments, the motion component of the mobile robot can be further configured to adopt a compensating position if the mobile robot's inclination is determined to not fall within a predetermined range. That is, the motion component can reduce the actual inclination by shifting with respect to the mobile robot. This can advantageously allow for normal operation of the beverage dispensing system as if the inclination was not outside predetermined ranges.

In embodiments where the motion component comprises a plurality of wheels and a wheel mechanism, those can be configured to actuate the mobile robot so as to adjust the mobile robot's inclination with respect to a surface that it is on. For example, in the case of the robot comprising five or more wheels that can be denoted as front wheels, middle wheels and back wheels, the robot may actuate one of those three tears, to provide vertical displacement to a part of the mobile robot. In other words, the robot's body and/or frame can be rotated so as to compensate for the detected inclination. This can also be used in a case of a flat tire to adjust the other tires so as to compensate for the flat one. The wheel mechanism can comprise, for example, levers connecting tires pairwise and allowing for a simultaneous lifting of one and raising of another, piston mechanisms and similar implementations.

In some such embodiments, the second processing component can be configured to communicate with the first processing component to request an actuation of the mobile robot if the mobile robot's inclination does not fall within a predetermined range. That is, the beverage module may be configured to detect the inclination that would interfere with its operation (via the sensor and its second processing component), and the mobile robot may be configured to compensate for it upon receiving a request from the beverage module. Additionally or alternatively, the inclination sensor may be directly connected with the mobile robot, and it would verify the inclination as part of the other possible requirements for starting beverage dispensing (e.g. also that the robot is stationary and the lid is open).

In some such embodiments, data from the inclination sensor can be saved with a corresponding location. That is, the mobile robot and/or the beverage component can be configured to collect inclination-related data, in order to reuse it in the future. This is particularly useful for inclination due to incline of the ground and/or unevenness of the ground, but not the one due to the mobile robot, such as a defect of the motion component. Collecting inclination/ground evenness data can be useful in order to know in advance whether a particular beverage dispensing location would not be suitable for beverage dispensing. In some such embodiments, the mobile robot and/or the beverage module can even collect inclination data while the robot is travelling, and not only at specific dispensing locations.

In some embodiments the beverage module can comprise at least two liquid containers. As discussed above, this can allow for different beverages to be dispensed via the system. Furthermore, with more liquid containers, a larger number of beverages can be dispensed without refilling/changing the beverage module.

In some embodiments, the second processing component can be configured to detect amount of remaining beverage in the beverage dispenser. This can be done by, for example, knowing the initial volume and tracking how much has been dispensed as beverages and/or by using a sensor for liquid detection.

In some embodiments, the beverage dispenser can comprise a lifter assembly configured for substantially linear displacement in at least one direction. The lifter assembly can be generally configured to move a beverage cup within the beverage module. The lifter assembly can comprise, for example, rails allowing for displacement along one of more axes. In some embodiments, the lifter assembly can be configured to move in a substantially vertical direction with respect to the mobile robot. For example, the lifter assembly can at least raise and lower beverage cups within the beverage module.

In some embodiments, the beverage module can further comprise a beverage cup assembly configured to hold a plurality of beverage cups. The beverage cups can be held as one or more stacks to optimize the available space. The beverage assembly can comprise one or more stacks of the beverage cups. A plurality of stacks can be particularly useful in case different sizes of beverage cups are stored in the beverage module. For example, the beverage cup assembly could have one stack of espresso cups, and one stack of larger beverage cups, such as a 0.2 litres, 0.25 litres and/or 0.3 litres cups.

In some such embodiments, the beverage dispenser can be configured for receiving beverage cups, actuating them to a filling position, and further actuating them to a dispensing position. The filling position can be configured so as to allow transfer of a beverage from the liquid container to the beverage cup. The dispensing position can be configured so as to allow a beverage recipient to retrieve the beverage cup. There can be a further third position of the beverage dispenser, a neutral position. In this position the beverage dispenser, or, preferably, the lifter assembly can receive a beverage cup on a cup plate. This can be the default or “resting” position of the beverage dispenser.

In some embodiments, the beverage module can further comprise a top surface. The top surface may serve to protect the beverage module from unauthorized access. The top surface can be preferably visible when the mobile robot's lid is opened. The top surface can further comprise a hatch comprising at least an open and a closed position. The hatch can be used to dispense a beverage cup container a beverage through it. That is, the hatch may remain closed unless a beverage is being dispensed (at which point the hatch may be controlled by the second processing component to assume an open position). The hatch may be substantially circular so as to provide an optimal shape for beverage cups.

In some such embodiments, the lifter assembly can be configured to bring the beverage cup to the hatch and through it above the top surface when the hatch is in an open position. That is, the beverage retrieving position may comprise a position where the beverage cup extends above the top surface, so that a beverage recipient may easily retrieve the beverage. The lifter assembly can be configured such that the maximum height of the beverage cup extending beyond the top surface comprises about 0.75 of the total height of the beverage cup, preferably between 0.55 and 0.85 of the beverage cup height, even more preferably between 0.65 and 0.8 of the beverage cup height. The present ranges for the maximum extension of the cup beyond the top surface can be particularly advantageous, as they simultaneously allow for a large portion of the cup to protrude above the top surface, thereby allowing a beverage recipient to easily retrieve the cup, while also providing sufficient support for the beverage cup via the sides of the hatch so that it does not tip and spill due to outside forces such as wind, accidental pushing by the beverage recipient and/or unplanned motion of the mobile robot.

Additionally or alternatively, the minimum distance between the lifter assembly and the top surface can comprise at least 5 cm, preferably at least 4 cm, most preferably at least 3 cm. Similarly to the above, ensuring that a sufficient chunk of the beverage cup remains below the top surface advantageously allows for both easy retrieval and protection from accidental cup tipping. A few centimetres (such as 3 or a bit more) can provide sufficient support for the cup while maximizing its protrusion beyond the top surface.

In some embodiments, the beverage module can further comprise at least one sensor. The sensor can be configured to measure at least one of temperature of liquid in the liquid container and level of liquid in the liquid container. Both are very useful to know to gauge how many more beverages can be dispensed before a refill and/or maintenance of the beverage container is required. The temperature sensor can be particularly useful for cases where pre-made beverage(s) is (are) present in the liquid container(s), particularly if only passive insulation is provided. Furthermore, the temperature sensor can be used to control the temperature of the beverage immediately before it is dispensed to a beverage recipient. This is two-fold useful: ensuring that no malfunction has occurred with the components of the beverage module (e.g. heating component malfunction) and ensuring the dispensed beverage comprises a temperature within an acceptable (and/or required) range for its type of beverage.

In some embodiments, the beverage module can further comprise at least one spill sensor configured to detect liquid outside expected areas of the beverage module. Expected areas are areas where liquid and/or beverage is expected to be present within the beverage module. For example, the liquid container and the beverage cup would be expected areas. On the contrary, in the vicinity of the second processing and communication components, on the top surface and on the lifting assembly (outside of the beverage cup) would all comprise unexpected areas. There may preferably be more than one spill sensor. The spill sensor can ensure that spills don't go undetected, and therefore that sensitive electronics and other components that may be damaged by liquids/beverages either remain operation or at least are identified as possibly compromised early on. Furthermore, undetected spills may pose a hygiene risk, which can be avoided by using the spill sensor.

In some such embodiments, the second processing component can be configured to communicate with the first processing component to request maintenance if the spill sensor detects an amount of liquid outside expected areas above a predetermined threshold. That is, the beverage module may let the mobile robot know that a spill has occurred (and preferably in which area depending on the number and sensitivity of spill sensors). The predetermined threshold may not be zero, since there may be some liquid condensation within the beverage module due to humidity and other parameters. This type of communication between the beverage module and the mobile robot is particularly useful, since it can ensure that maintenance is swiftly seeked and that damage due to the spill is minimized.

In some embodiments, the beverage module can further comprise a first taste agent. The taste agent can comprise an ingredient of the beverage such as coffee beans, cacao powder, sugar, milk, whipped cream and/or other similar components. The beverage module can then be configured to combine the first taste agent with liquid from the liquid container to produce a beverage. The beverage module can further comprise a first modifier configured to modify the first taste agent. The modifier can be a foamer, configured to foam milk for example. The modifier can also comprise a grinder, configured to grind coffee beans. Some taste agent may not require modification, and can just directly be mixed with the rest of the beverage. The taste agent may be selected and specified by a user requesting a beverage. Therefore, offering a plurality of taste agents advantageously increases the personalisation of the dispensed beverage.

In some preferred embodiments, the beverage dispensing system can further comprise a server configured to communicate with the first and second communication components. The server can be a remote server, a cloud server, a collection of servers and/or a similar aggregation of computing power. The server can generally monitor, coordinate and/or control the operations of the mobile robot and the beverage component. Furthermore, there may be a plurality of mobile robots and beverage components, all of which the server can coordinate.

The server can be configured to receive a status of the beverage module and direct the mobile robot to navigate to a predetermined location based on the status. The status of the beverage module can comprise at least one of low beverage levels, maintenance required, spill detected, low battery level, and temperature of beverage outside predetermined levels. That is, the server may receive an alert indicative of one of the above status conditions and recognize that the beverage module may need to be serviced/replaced/maintained. In this case, the server may send the mobile robot to an appropriate predetermined location where this can be achieved.

In some such embodiments, the system can further comprise a hub configured to at least one of refilling the beverage module with liquid, servicing the beverage module, and maintaining the beverage module. The predetermined location where the server may send the robot for servicing/refilling/maintenance may then comprise a hub. The hub can be a physical structure and/or a part of a building. The hub can preferably be operated substantially automatically. The hub may be configured to replace one beverage module within a mobile robot with another and/or place a beverage module inside another robot. The hub may also be configured to service/maintain a mobile robot, by e.g. replacing its battery, providing calibration for its sensors, visually and/or otherwise diagnosing the health of the robot and otherwise.

In some embodiments, the server can be further configured to receive a beverage request from a beverage recipient and direct the mobile robot the beverage recipient's location to dispense a beverage via the beverage module.

In some embodiments, the beverage dispensing system can further comprise a user interface configured for communicating with the server. The user interface can comprise an input/output interface, such as, for example, a program on a user's personal computing device (e.g. an app on a smartphone). The user interface can be configured for transmitting requests for a beverage at a user-specified location. Note, that the user and the beverage recipient may be different persons, as the user could order a beverage for another person, e.g. a friend.

The user interface can comprise at least one beverage parameter that can be selected by a user. That is, when ordering a beverage via the user interface, the user may be prompted to select their drink and/or personalize it according to their tastes. For example, the user interface may comprise an option for preparing specialty drinks such as hot chocolate, cappuccino, latte macchiato, espresso, chai/matcha latte, and/or others. The user interface can further comprise an option to select at least one taste agent. That is, the user interface might have options to add sugar, milk and/or whipped cream to the beverage.

The user interface can further comprise an option to use a recipient's cup for beverage dispensing. That is, the beverage dispenser can be configured to receive a recipient's cup, actuate it to a filling position, and further actuate it to a dispensing position. The filling position can be configured so as to allow transfer of a beverage from the liquid container to the beverage cup. The dispensing position can be configured so as to allow a beverage recipient to retrieve the beverage cup. Allowing the beverage recipient to provide their own cup can be advantageous, as it encourages use of reusable cups, as well as energy and resource optimization. Furthermore, a user may prefer to use their own cup rather than a one-time use disposable cup (as it can have better isolation, grip etc). The user interface may also comprise options for the user's cup size, i.e. those that would be compatible with the beverage module. Additionally, the beverage module may perform a verification that recipient's cup's dimensions do not exceed compatible ones.

In some embodiments, the server can be further configured to verify whether inclination data is available for the user-specified location and verifying that it is within a predefined range if it is. That is, if a user request beverage dispensing a particular dispensing location (used here synonymously with user-specified location), the server may check whether this location can pose problem with beverage dispensing. This can allow for preparation in advance. The server can be further configured to suggest an alternative location if the inclination at the user-specified location does not fall within a predetermined range. The alternative location can be in the vicinity of the user-specified location and have an inclination that does not interfere with beverage dispensing.

In some such embodiments, the server can be further configured to collect data from the inclination sensor of a plurality of mobile robots and generate a map of inclination based on the data. The map of inclination can advantageously be used to avoid or at least be prepared for areas with high inclination, where dispensing beverages may be harder or not possible without adjusting inclination of the mobile robot. The map can be regularly updated, either as various mobile robots travel through various areas on the way to beverage dispensing locations and/or by other means.

In a second embodiment, a method for dispensing beverages is disclosed. The method comprises a mobile robot comprising a motion component, a first processing component and a robot communication component travelling to a first location by using the motion component. The method further comprises, at the first location, preparing a beverage via a beverage module fitted to the mobile robot and comprising at least one liquid container, at least one beverage dispenser, a second processing component, and a second communication component. The method also comprises dispensing the beverage to a beverage recipient via the beverage dispenser. The method further comprises the mobile robot departing the first location.

As also discussed above in relation to the first embodiment, the method is particularly advantageous as it allows for a device for beverage dispensing that is configured to move and travel and navigate, particularly also in outdoor surroundings.

In some embodiments, the method can also comprise the first communication component and the second communication component communicating with each other to exchange data related to preparing and dispensing the beverage to the beverage recipient. The first processing component and the second processing component can coordinate providing a beverage to the beverage recipient via the communicating between the first communication component and the second communication component. For instance, such coordination can comprise the first processing component ensuring the mobile robot came to a halt before communicating to the second processing component via the first and second communication components that the beverage can be distributed to the beverage recipient. Waiting until the robot stops to start distributing a beverage can help prevent any possible spills and/or errors during beverage distribution and/or preparation. This can be particularly important for robots travelling outdoors and/or in unstructured environments (as compared to more structured environments such as insides of buildings, rooms, hallways etc), since the surface of travel are generally more uneven, and therefore a lot more vibration and/or various forces may be applied to the beverage module. Therefore, waiting until a robot comes to a halt can advantageously ensure a more reliable beverage preparing and/or dispensing process, as well as minimization of spills.

In some embodiments, the mobile robot can further comprise a lockable lid arranged so as to prevent access to the beverage module in a closed position and allow access to at least part of the beverage module in an open position. The method can then further comprise the first processing component causing the lid to change from the closed position to the open position before communicating to the second processing component via the first and second communication components that the beverage can be distributed to the beverage recipient. This communication between the mobile robot and the beverage module can be very important to ensure that dispensing of the beverage can be performed. When the lid of the robot is closed, dispensing the beverage may result in a beverage cup hitting the inside of the robot lid, thereby resulting in a spill and/or possible malfunction. Therefore, precise coordination between the mobile robot and the beverage module yields a reliable and efficient beverage distribution process.

In some embodiments, the method can further comprise, prior to dispensing a beverage via the beverage module, measuring the mobile robot's inclination based on data from an inclination sensor. Then, the method can also further comprise aborting beverage dispensing if the measured inclination does not fall within a predetermined range. This step of the method can also serve to ensure the safety and reliability of the beverage dispensing method, as dispensing a beverage while the robot is standing on a steep slope (and/or while it is standing on uneven surface/has a malfunction in the motion component) can lead to spills, beverage module malfunctions and general failures of the dispensing.

In some such embodiments, the mobile robot can adopt a compensating position if the mobile robot's inclination is determined to be outside a predetermined range. This method step can advantageously allow to dispense the beverage even if the surface characteristics/motion component malfunctions would otherwise prevent this. For example, the motion component can comprise a plurality of wheels and a wheel mechanism. Then, this method step can comprise the wheel mechanism actuating the mobile robot so as to adjust the mobile robot's inclination with respect to a surface that it is on. That is, the wheel mechanism may adjust some of the wheels independently of the other wheels, resulting in artificial inclination and/or rotation of the robot with respect to the surface it is resting on.

In some such method embodiments, the second processing component can request the first processing component for an actuation of the mobile robot if the mobile robot's inclination does not fall within a predetermined range. That is, the beverage module may request that the mobile robot travels to a surface with a more acceptable inclination, preferably located in the vicinity of the present location.

The method can also comprise saving inclination data from the inclination sensor with a corresponding location. This can help avoid stopping for beverage dispensing in areas with a steep inclination in the future. Additionally or alternatively, the mobile robot can be better prepared for compensating the inclination.

In some method embodiments, the beverage module can further comprise a beverage cup assembly configured to hold a plurality of beverage cups. The method can then further comprise the beverage dispenser receiving a beverage cup, actuating it to a filling position, and further actuating it to a dispensing position. The filling position can be configured so as to allow transfer of a beverage from the liquid container to the beverage cup. The dispensing position can be configured so as to allow a beverage recipient to retrieve the beverage cup. There can further be a neutral position in which the beverage dispenser can receive the beverage cup.

In some preferred embodiments, the beverage module can further comprise a top surface with a hatch comprising at least an open and a closed position. Then dispensing the beverage can comprise actuating the hatch to assume an open position and lifting the beverage cup through the hatch up to maximum height of about 0.75 of the beverage cup height, preferably up to a maximum height of between 0.55 and 0.85 of the beverage cup height, even more preferably up to a maximum height of between 0.65 and 0.8 of the beverage cup height. As discussed previously, this height ratio can be particularly useful for ensuring the balance between stability of the beverage cup and ease of access for a beverage recipient.

In some embodiments, the method can further comprise measuring at least one of a temperature of liquid in the liquid container, an amount of liquid in the liquid container, a presence of liquid outside expected areas of the beverage module, and requesting maintenance if at least one of the above is outside predetermined ranges. The predetermined ranges for temperature may comprise a temperature of below about 50° C. for warm beverages and above 15° C. for cold beverages. For amount of liquid, amounts sufficient for less than 2 or 3 standard beverages may necessitate requesting maintenance (i.e. refilling/replacement of the beverage module).

In some preferred embodiments, the method can further comprise a server communicating with the first and second communication components.

The server can receive a status of the beverage module and direct the mobile robot to navigate to a predetermined location based on the status. The possible statuses causing the server to direct the mobile robot the predetermined location are listed above in the description to the first preferred embodiment. The server might be better placed to evaluate the status of the beverage module and make a decision based on it, as it may have a lot more information about possible statuses and consequences, as well as the presence of other mobile robots and beverage components in the vicinity, which may be important for determining whether a certain one can be taken off active duty.

In some embodiments the method can further comprise the server receiving a beverage request from a beverage recipient and directing the mobile robot to the beverage recipient's location to dispense a beverage via the beverage module. That is, the beverage recipient may request on-demand beverage delivery. The server can coordinate all of such requests and decide which robot should be sent to which beverage recipient.

In some such embodiments, the method can further comprise the server directing the mobile robot to roam a target area. The target area can be identified as likely having a plurality of beverage recipients interested in receiving a beverage via the beverage module. For example, a target area may be a park in a city during weekends/evenings and/or lunchtime. During these times and in such a location, there might be many persons desiring a beverage. The present beverage dispensing system can then conveniently arrive to their preferred location and dispense a beverage. Other roaming areas may include campuses (working and/or university), shopping streets, zoos, public swimming pools or similar locations where beverages might be desired.

In some embodiments, the method can further comprise the server directing the mobile robot to a hub for at least one of refilling the beverage module with liquid, servicing the beverage module, and maintaining the beverage module. The server can do this upon receiving data indicative of the beverage module requiring at least one of the above.

In some embodiments, the method can further comprise, prior to the mobile robot travelling to the first location, receiving a beverage request to the first location from a user via a user interface. That is, the mobile robot can travel to a user-specified location (first location) on demand from a user to dispense a beverage to a beverage recipient (which may be the same person as the user, but need not be).

In some such embodiments, the method can further comprise receiving at least one beverage parameter from a user via a user interface and preparing a beverage with the corresponding beverage parameter. The beverage parameter can be, for instance, the type of beverage that the user can select. E.g. a type of coffee such as espresso, cappuccino, latte; tea, hot chocolate, soft drinks and/or juice. The beverage parameter can also comprise the amount of beverage and/or its temperature. Additionally or alternatively, a user my be able to add taste agents such as milk, sugar, and/or whipped cream to the beverage.

In some embodiments the method can further comprise receiving a request for a beverage dispensed in a recipient's cup and dispensing the beverage in the recipient's cup. That is, the user may request via the user interface that the beverage recipient would prefer to use their own cup for the beverage. The beverage module can then receive the recipient's cup and return it with the dispensed beverage. This can allow for optimization of resources and more convenient experience.

In some embodiments, the method can further comprising verifying whether inclination data is available for the first location and verifying that it is within a predefined range if it is. It can further comprise suggesting an alternative location if the inclination at the user-specified location does not fall within a predetermined range. This can be done, for example, via the user interface and the suggestion can comprise a location in the vicinity of the first location.

In some embodiments, the method can further comprise the server collecting data from the inclination sensor of a plurality of mobile robots and the server generating a map of inclination based on the collected data. It can be fairly advantageous to have a map of an area with areas where inclination may exceed certain thresholds indicated. The mobile robot can then either avoid those areas and/or additionally prepare for operation there. For instance, only certain types of beverages (such as pre-made ones without taste agents) might be available in those areas so as to minimize the risk of spills and/or malfunctions.

Below, a description of the mobile robot's autonomy capabilities follows.

The mobile robot can be an autonomous or a semi-autonomous robot configured for ground-based travel. Note, that as used herein, the terms autonomous or semi-autonomous robot can be used to mean any level of automation depending on the task that the robot is performing. That is, the robot can be adapted to function autonomously or semi-autonomously for most of the tasks, but can also be remotely controlled for some other tasks. Then, the robot would be non-autonomous during the time it is controlled, and then autonomous and/or semi-autonomous again when it is no longer controlled. For example, the robot can assume any of the levels of automation as defined by the Society of Automotive Engineers (SAE), that is, the levels as given below.
Level 0—No Automation
Level 1—Driver Assistance
Level 2—Partial Automation
Level 3—Conditional Automation
Level 4—High Automation
Level 5—Full Automation

Though the levels usually refer to vehicles such as cars, they can also be used in the context of the mobile robot. That is, Level 0 can correspond to a remote terminal fully controlling the robot. Levels 1-4 can correspond to the remote terminal partially controlling the robot, that is, monitoring the robot, stopping the robot or otherwise assisting the robot with the motion. Level 5 can correspond to the robot driving autonomously without being controlled by a remote terminal such as a server or a remote operator (in this case, the robot can still be in communication with the remote terminal and receive instructions at regular intervals).

The present invention is also defined by the following numbered embodiments.

Below is a list of system embodiments. Those will be indicated with a letter “S”. Whenever such embodiments are referred to, this will be done by referring to “S” embodiments.

S1. A beverage dispensing system comprising
A mobile robot comprising a motion component, a first processing component and a first communication component; and
A beverage module fitted to the mobile robot and comprising at least one liquid container, at least one beverage dispenser, a second processing component, and a second communication component.

### Embodiments Related to Interaction Between the Beverage Module and the Robot

S2. The system according to the preceding embodiment wherein the beverage module is removably fitted to an opening within the mobile robot's body.

S3. The system according to any of the preceding embodiments wherein the mobile robot further comprises a lockable lid arranged so as to prevent access to the beverage module in a closed position and allow access to at least part of the beverage module in an open position.

S4. The system according to any of the preceding embodiments wherein the first communication component and the second communication component are configured to communicate with each other.

S5. The system according to the preceding embodiment wherein the first communication component and the second communication component are configured to exchange data related to preparing a beverage and dispensing it to a beverage recipient.

S6. The system according to the preceding embodiment wherein the first processing component and the second processing component are configured to coordinate providing a beverage to the beverage recipient via the first communication component and the second communication component.

S7. The system according to the preceding embodiment and with the features of embodiment S3 wherein the coordination further comprises the first processing component ensuring that the motion component is not causing the robot to move and that the lockable lid is in the open position before the second processing component causes the beverage module to prepare a beverage and dispense it to a beverage recipient.

S8. The system according to any of the preceding embodiments further comprising at least one inclination sensor and wherein prior to dispensing a beverage via the beverage module, at least one of the first processing component and the second processing component determines mobile robot's inclination based on data from the inclination sensor.

S9. The system according to the preceding embodiment wherein the second processing component is configured to abort beverage dispensing if the mobile robot's inclination does not fall within a predetermined range.

S10. The system according to the preceding embodiment wherein the motion component of the mobile robot is further configured to adopt a compensating position if the mobile robot's inclination is determined to not fall within a predetermined range.

S11. The system according to the preceding embodiment wherein the motion component comprises a plurality of wheels and a wheel mechanism configured to actuate the mobile robot so as to adjust the mobile robot's inclination with respect to a surface that it is on.

S12. The system according to any of the preceding four embodiments wherein the second processing component is configured to communicate with the first processing component to request an actuation of the mobile robot if the mobile robot's inclination does not fall within a predetermined range.

S13. The system according to any of the five preceding embodiments wherein data from the inclination sensor is saved with a corresponding location.

### Embodiments Related to the Physical Configuration of the Beverage Module

S14. The system according to any of the preceding embodiments wherein the beverage module comprises at least two liquid containers.

S15. The system according to any of the preceding embodiments wherein the second processing component is configured to detect amount of remaining beverage in the beverage dispenser.

S16. The system according to any of the preceding embodiments wherein the beverage dispenser comprises a lifter assembly configured for substantially linear displacement in at least one direction.

S17. The system according to the preceding embodiment wherein the lifter assembly is configured to move in a substantially vertical direction with respect to the mobile robot.

S18. The system according to any of the preceding embodiments wherein the beverage module further comprises a beverage cup assembly configured to hold a plurality of beverage cups.

S19. The system according to the preceding embodiment wherein the beverage dispenser is configured for receiving beverage cups, actuating them to a filling position, and further actuating them to a dispensing position and wherein
the filling position is configured so as to allow transfer of a beverage from the liquid container to the beverage cup; and
the dispensing position is configured so as to allow a beverage recipient to retrieve the beverage cup.

S20. The system according to any of the preceding embodiments wherein the beverage module further comprises a top surface.

S21. The system according to the preceding embodiment wherein the top surface comprises a hatch comprising at least an open and a closed position.

S22. The system according to the preceding embodiment and with the features of embodiments S10 and S12 wherein the lifter assembly is configured to bring the beverage cup to the hatch and through it above the top surface when the hatch is in an open position.

S23. The system according to the preceding embodiment wherein the lifter assembly is configured such that the maximum height of the beverage cup extending beyond the top surface comprises about 0.75 of the total height of the beverage cup, preferably between 0.55 and 0.85 of the beverage cup height, even more preferably between 0.65 and 0.8 of the beverage cup height.

S24. The system according to any of the preceding embodiments and with the features of embodiment S16 wherein the minimum distance between the lifter assembly and the top surface comprises at least 5 cm, preferably at least 4 cm, most preferably at least 3 cm.

S25. The system according to any of the preceding embodiments wherein the beverage module further comprises at least one sensor.

S26. The system according to the preceding embodiment wherein the sensor is configured to measure at least one of
Temperature of liquid in the liquid container; and
Level of liquid in the liquid container.

S27. The system according to any of the preceding embodiments wherein the beverage module further comprises at least one spill sensor configured to detect liquid outside expected areas of the beverage module.

S28. The system according to the preceding embodiment wherein the second processing component is configured to communicate with the first processing component to request maintenance if the spill sensor detects an amount of liquid outside expected areas above a predetermined threshold.

S29. The system according to any of the preceding embodiments wherein the beverage module further comprises a first taste agent.

S30. The system according to the preceding embodiment wherein the beverage module is configured to combine the first taste agent with liquid from the liquid container to produce a beverage.

S31. The system according to any of the two preceding embodiments wherein the beverage module further comprises a first modifier configured to modify the first taste agent.

### Embodiments Related to the Architecture of the System

S32. The system according to any of the preceding embodiments further comprising a server configured to communicate with the first and second communication components.

S33. The system according to the preceding embodiment wherein the server is configured to receive a status of the beverage module and direct the mobile robot to navigate to a predetermined location based on the status.

S34. The system according to the preceding embodiment wherein the status of the beverage module comprises at least one of
Low beverage levels;
Maintenance required;
Spill detected;
Low battery level; and
Temperature of beverage outside predetermined levels.

S35. The system according to any of the two preceding embodiments wherein the system further comprises a hub configured to at least one of
Refill the beverage module with liquid;
Service the beverage module; and
Maintain the beverage module
   And wherein the predetermined location comprises the hub.

S36. The system according to any of the preceding embodiments and with the features of embodiment S32 wherein the server is further configured to receive a beverage request from a beverage recipient and direct the mobile robot the beverage recipient's location to dispense a beverage via the beverage module.

S37. The system according to any of the preceding embodiments and with the features of embodiment S32 further comprising a user interface configured for communicating with the server.

S38. The system according to the preceding embodiment wherein the user interface is configured for transmitting requests for a beverage at a user-specified location.

S39. The system according to any of the two preceding embodiments wherein the user interface comprises at least one beverage parameter that can be selected by a user.

S40. The system according to any of the three preceding embodiments wherein the user interface further comprises an option to use a recipient's cup for beverage dispensing.

S41. The system according to the preceding embodiment wherein the beverage dispenser is configured to receive a recipient's cup, actuate it to a filling position, and further actuate it to a dispensing position and wherein
the filling position is configured so as to allow transfer of a beverage from the liquid container to the beverage cup; and
the dispensing position is configured so as to allow a beverage recipient to retrieve the beverage cup.

S42. The system according to any of the five preceding embodiments and with the features of embodiment S29 wherein the user interface further comprises an option to select at least one taste agent.

S43. The system according to any of the preceding embodiments and with the features of embodiment S13 and S38 wherein the server is further configured to verify whether inclination data is available for the user-specified location and verifying that it is within a predefined range if it is.

S44. The system according to the preceding embodiment wherein the server is further configured to suggest an alternative location if the inclination at the user-specified location does not fall within a predetermined range.

S45. The system according to any of the two preceding embodiments wherein the server is further configured to collect data from the inclination sensor of a plurality of mobile robots and generate a map of inclination based on the data.

Below is a list of method embodiments. Those will be indicated with a letter “M”. Whenever such embodiments are referred to, this will be done by referring to “M” embodiments.

M1. A method for dispensing beverages, the method comprising

A mobile robot comprising a motion component, a first processing component and a robot communication component travelling to a first location by using the motion component; and

At the first location, preparing a beverage via a beverage module fitted to the mobile robot and comprising at least one liquid container, at least one beverage dispenser, a second processing component, and a second communication component; and

Dispensing the beverage to a beverage recipient via the beverage dispenser; and

The mobile robot departing the first location.

M2. The method according to the preceding embodiment further comprising the first communication component and the second communication component communicating with each other to exchange data related to preparing and dispensing the beverage to the beverage recipient.

M3. The method according to the preceding embodiment further comprising the first processing component and the second processing component coordinating providing a beverage to the beverage recipient via the communicating between the first communication component and the second communication component.

M4. The method according to the preceding embodiment further comprising the first processing component ensuring the mobile robot came to a halt before communicating to the second processing component via the first and second communication components that the beverage can be distributed to the beverage recipient.

M5. The method according to any of the preceding method embodiments and with the features of embodiment M3 wherein the mobile robot further comprises a lockable lid arranged so as to prevent access to the beverage module in a closed position and allow access to at least part of the beverage module in an open position; and wherein the method further comprises
the first processing component causing the lid to change from the closed position to the open position before communicating to the second processing component via the first and second communication components that the beverage can be distributed to the beverage recipient.

M6. The method according to any of the preceding method embodiments further comprising, prior to dispensing a beverage via the beverage module,
measuring the mobile robot's inclination based on data from an inclination sensor.

M7. The method according to the preceding embodiment further comprising
aborting beverage dispensing if the measured inclination does not fall within a predetermined range.

M8. The method according to any of the two preceding embodiments further comprising
the mobile robot adopting a compensating position if the mobile robot's inclination is determined to be outside a predetermined range.

M9. The method according to the preceding embodiment wherein the motion component comprises a plurality of wheels and a wheel mechanism and wherein the method further comprises
the wheel mechanism actuating the mobile robot so as to adjust the mobile robot's inclination with respect to a surface that it is on.

M10. The method according to any of the four preceding embodiments further comprising
the second processing component requesting the first processing component for an actuation of the mobile robot if the mobile robot's inclination does not fall within a predetermined range.

M11. The method according to any of the five preceding embodiments further comprising saving inclination data from the inclination sensor with a corresponding location.

M12. The method according to any of the preceding method embodiments wherein the beverage module further comprises a beverage cup assembly configured to hold a plurality of beverage cups and wherein the method further comprises
the beverage dispenser receiving a beverage cup, actuating it to a filling position, and further actuating it to a dispensing position and wherein
   the filling position is configured so as to allow transfer of a beverage from the liquid container to the beverage cup; and
   the dispensing position is configured so as to allow a beverage recipient to retrieve the beverage cup.

M13. The method according the preceding embodiment wherein the beverage module further comprises a top surface with a hatch comprising at least an open and a closed position and wherein dispensing the beverage comprises
actuating the hatch to assume an open position; and
lifting the beverage cup through the hatch up to maximum height of about 0.75 of the beverage cup height, preferably up to a maximum height of between 0.55 and 0.85 of the beverage cup height, even more preferably up to a maximum height of between 0.65 and 0.8 of the beverage cup height.

M14. The method according to any of the preceding embodiments further comprising measuring at least one of
a temperature of liquid in the liquid container;
an amount of liquid in the liquid container;
a presence of liquid outside expected areas of the beverage module;
   and requesting maintenance if at least one of the above is outside predetermined ranges.

M15. The method according to any of the preceding method embodiments further comprising
a server communicating with the first and second communication components.

M16. The method according to the preceding embodiment further comprising the server receiving a status of the beverage module and directing the mobile robot to navigate to a predetermined location based on the status.

M17. The method according to any of the two preceding embodiments further comprising the server receiving a beverage request from a beverage recipient and directing the mobile robot to the beverage recipient's location to dispense a beverage via the beverage module.

M18. The method according to any of the three preceding embodiments further comprising the server directing the mobile robot to roam a target area and wherein
the target area is identified as likely having a plurality of beverage recipients interested in receiving a beverage via the beverage module.

M19. The method according to any of the preceding method embodiments and with the features of embodiment M14 further comprising
the server directing the mobile robot to a hub for at least one of
   refilling the beverage module with liquid;
   servicing the beverage module; and
   maintaining the beverage module;
upon receiving data indicative of the beverage module requiring at least one of the above.

M20. The method according to any of the preceding method embodiments further comprising, prior to the mobile robot travelling to the first location,
receiving a beverage request to the first location from a user via a user interface.

M21. The method according to the preceding embodiment further comprising
receiving at least one beverage parameter from a user via a user interface; and
preparing a beverage with the corresponding beverage parameter.

M22. The method according to any of the two preceding embodiments further comprising
receiving a request for a beverage dispensed in a recipient's cup; and
dispensing the beverage in the recipient's cup.

M23. The method according to any of the preceding method embodiments and with the features of embodiments M11 and M20 further comprising
verifying whether inclination data is available for the first location and verifying that it is within a predefined range if it is.

M24. The method according to the preceding embodiment further comprising
suggesting an alternative location if the inclination at the user-specified location does not fall within a predetermined range.

M25. The method according to any of the preceding method embodiments and with the features of embodiments M11 and M15 further comprising
the server collecting data from the inclination sensor of a plurality of mobile robots; and
the server generating a map of inclination based on the collected data.

The present technology will now be discussed with reference to the accompanying drawings.

### BRIEF DESCRIPTION OF THE DRAWINGS

FIG. 1 depicts an embodiment of a beverage module fitted to a mobile robot;

FIG. 2 schematically depicts a beverage dispensing system with a server;

FIG. 3 schematically depicts the components of the beverage module according to an embodiment of the invention;

FIG. 4 schematically depicts an exemplary embodiment of an optional beverage preparation component;

FIG. 5 schematically depicts an exemplary embodiment of a beverage dispenser;

FIG. 6 depicts an embodiment of the beverage module with a beverage cup;

FIG. 7 shows an embodiment of the beverage module with transparent walls;

FIG. 8 shows an embodiment of the mobile robot configured to be fitted with a beverage module; and

FIG. 9 shows an embodiment of a method for dispensing beverages.

### DESCRIPTION OF EMBODIMENTS

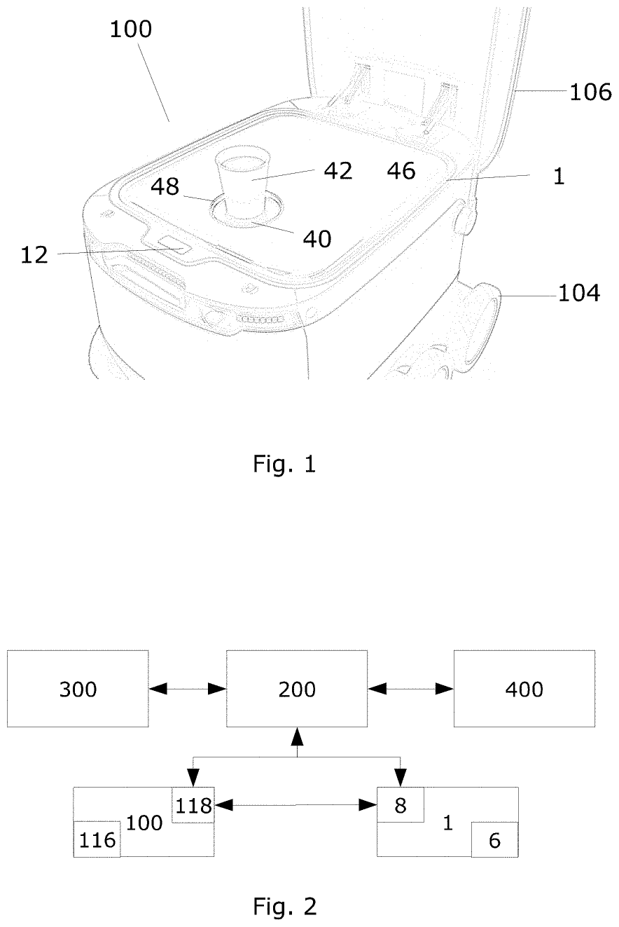

FIG. 1 schematically depicts an embodiment of a mobile robot 100 with a beverage module 1 fitted to it.

The mobile robot 100 with the beverage module 1 can generally be used to dispense drinks to individuals. The mobile robot 100 can serve as a mobile on-demand vending machine for drinks and/or roam a certain area and be flagged down as desired by users. Users can generally interact with the mobile robot 100 and the beverage module 1 via a user interface such as an interface (e.g. app) on a personal computing device. The beverage module 1 can be loaded with components for preparing a beverage. Preferably, the beverage module 1 comprises a base liquid (such as water), and optionally further ingredients. For instance, the beverage module 1 can comprise coffee beans, milk, sugar and water. Additionally or alternatively, the beverage module 1 can comprise a pre-made beverage such as coffee, tea, hot chocolate, soft drink, juice or similar. There may be more than one pre-made beverage in the beverage module and/or there may be ingredients for making two or more different types of beverages.

In FIG. 1, the beverage module 1 is fitted to the mobile robot 100. Preferably, it is removably fitted, so that it can be quickly exchanged for another beverage module 2 (for example, instead of immediately refilling and/or servicing an empty and/or defective beverage module 1. The removable fitting can be executed via a securing component 12. The securing component 12 can comprise a lock, such as a mechanical lock.

The mobile robot 100 comprises a motion component 104, shown as wheels 104. The motion component 104 provides mobility to the mobile robot 100 and the beverage module 1. The mobile robot 100 further comprises a lid 106. The lid 106 can ensure that the beverage module 1 is protected and inaccessible while the mobile robot 100 is moving, as well as prevent unauthorized access to the beverage module 1. The lid can have an electronic lock that can be controlled remotely and/or directly by a processing component of the mobile robot 100.

The beverage module 1 is shown fitted inside an opening within the mobile robot 1. Top surface 46 is shown, along with a hatch 48. The top surface 46 can serve to prevent access to the insides of the beverage module 1 and to ensure that electronics and further components of the beverage module 1 are protected both from unauthorized use, as well as from the elements and/or unnecessary wear and tear.

The hatch 48 can comprise a substantially circular component that can be actuated into an open and a closed position. In FIG. 1, the hatch 48 is shown in the open position. While the mobile robot 100 is travelling, the hatch would generally assume a close position as well. When the beverage is being dispensed, the hatch 48 would open to allow a beverage cup 42 to be lifted through it. In FIG. 1, the beverage cup 42 is resting on a component of a beverage dispenser 4, lifter assembly 40. The hatch 48 is preferably depressed with respect to the top surface 46. The amount of depression is preferably around 25% of the height of the beverage cup 42. Additionally or alternatively, the amount of depression can be at least 3 cm. This can particularly allow for the beverage cup 42 to be supported while being lifted and while resting on the lifter assembly 40 after being lifted through the hatch 48. Furthermore, while a beverage recipient lifts the cup 42 from the lifter assembly 40, the additional support can help avoid spills due to abrupt movements.

FIG. 2 schematically shows communication within the beverage dispensing system, including some optional elements of the system. The mobile robot 100 and the beverage module 1 are configured to communicate via the first communication component 118 and the second communication component 8 respectively. In other words, each of the mobile robot 100 and the beverage module 1 preferably have a separate controlling and processing systems. The communication between the mobile robot 100 and the beverage module 1 can be established via different protocols. There could also be more than one protocol used as a failsafe.

The beverage module 1 can send the mobile robot 100 information relating to its status, such as remaining amount of beverage, temperature, health status, the presence of any spills, status of beverage dispensing, and/or further data based on self-diagnostics and/or sensor data.

The mobile robot 100 can send the beverage module 1 information or commands related to starting of the beverage dispensing process. For example, the mobile robot 100 may inform the beverage module 1 that it has stopped and that the lid has been unlocked and opened, thereby allowing the beverage module 1 to start producing the beverage and/or to dispense the beverage.

Both the beverage module 1 and the mobile robot 100 can be configured to communicate with a server 200. The server 200 can be a remote server, a cloud server and/or a collection of servers. The server 200 is an optional element of the beverage dispensing system. The server 200 can coordinate operations of a plurality of robots 100 and beverage modules 1. The server 200 can receive status updates from both the mobile robot 100 and the beverage module 1. Additionally or alternatively, all of the communication from the beverage module 1 can pass through the mobile robot 100. This embodiment is not depicted in FIG. 2, where the communication is indicated by arrows. The server 200 can further send instructions and/or commands to the mobile robot 100 and/or to the beverage module 1. For example, commands may comprise directions for the mobile robot 100 to navigate to a certain location. Commands may also comprise directions for the beverage module 1 to prepare a beverage according to certain specifications and/or with certain parameters.

A further optional element of the beverage dispensing system is a user interface 300. The user interface 300 can communicate with the remote server 200. Additionally or alternatively, the user interface 300 can communicate with the mobile robot 100 and/or the beverage module 1. The user interface 300 can comprise an interface on a user's personal computing device, for example, a smartphone app. The user interface 300 can comprise a plurality of options or parameters that can be chosen and/or set by the user. For instance, the user may have the option to set a location where the mobile robot 100 should travel to dispense a beverage via the beverage module 1. Additionally or alternatively, parameters related to beverage type (e.g. coffee, tea, hot chocolate, juice, lemonade, soft drinks etc.), beverage taste agents (such as sugar, milk etc.), and/or beverage temperature may be input via the user interface 300. The server 200 can communicate with the user interface 300 by sending information regarding the status of the beverage delivery, for example the location of the mobile robot 200.

Another optional element of the beverage dispensing system is a hub 400. The hub 400 can comprise a physical structure or building and/or a location within a building or area. The hub 400 can service, repair, maintain and/or reload the beverage module 1 and/or the mobile robot. The hub 400 is preferably configured to operate largely autonomously. The hub 400 may be configured to replace one beverage module 1 for another, for instance if the first one is empty and/or defective. Additionally or alternatively, the hub 400 may be configured to refill the beverage module 1. The hub 400 is also preferably configured to replace a battery of the mobile robot and/or of the beverage module 1. The server 200 may contact the hub 400 in case a mobile robot 100 and/or a beverage module 1 requires maintenance, refilling, recharging and/or servicing, to verify whether the hub 400 can perform the task (i.e. whether it has the capacity, whether it is operational, etc.). If the hub 400 confirms, the server 200 may direct the mobile robot 100 to navigate to the hub. There may be a plurality of different hubs 400, located at different locations and servicing a plurality of mobile robots 100 and beverage modules 1.

An exemplary operation of the beverage dispensing system will be described below. In the morning, a plurality of beverage modules 1 may be prepared (e.g. loaded with coffee beans, tea leaves, and/or pre-made beverages) at various hubs 400 and fitted to mobile robots 100. The mobile robots 100 may then leave the hubs 400 and travel to an area as directed by the server 200. The robots 100 may then roam the area and/or remain stationary at a certain location.

A request for a beverage can then be received by the server via the user interface 300. That is, a user may open the app, select a coffee with added sugar and milk, and select a location where the beverage should be dispensed. The server 200 may then compute which mobile robot 100 is most suitable to dispense the desired beverage (based on the status of the robot's 100 and beverage modules 1, dispensing location, other beverage requests, type of beverage requested etc), and direct this mobile robot 100 to travel to the indicated location. The mobile robot 100 may then arrive at the dispensing location.

There may be an authentication between the mobile robot 100 and the user interface 300. For example, the server 200 may request that the user interface 300 confirms readiness to receive a beverage (e.g., the user may need to confirm that they see the robot). The mobile robot 100 may then unlock the lid 106 and communicate to the beverage module 1 that the beverage may be dispensed. The beverage module 1 can then prepare the beverage and dispense it to a beverage recipient via the hatch 48 in the top surface 46.

Note, that the beverage recipient and user using the user interface may be the same person or not (e.g. a user may order a beverage for a friend at a different location than their own).

A user may further request to use their own cup or container for beverage dispensing. In this case, there may be further parameters to input via the user interface 300, such as dimensions of the cup. If this option is chosen, the user may be prompted by the server 200 to place their cup on the lifter assembly 40 and wait until it is filled with a beverage.

After dispensing the beverage, the beverage module 1 may close the hatch 48 and signal to the mobile robot 100 that the process is complete. Then, the mobile robot 100 may close the lid 46, and depart the dispensing location.

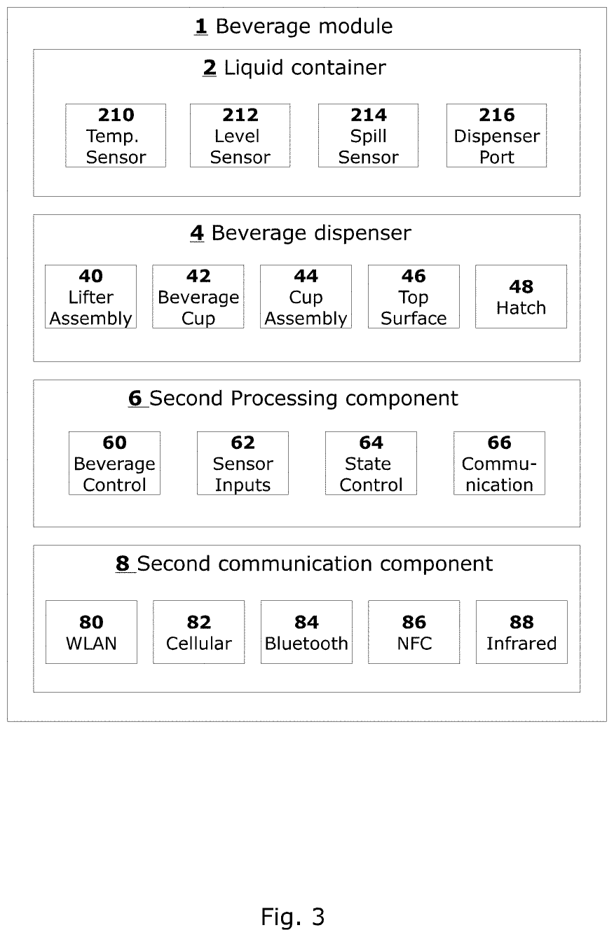

FIG. 3 schematically shows an embodiment of the beverage module 1. The beverage module 1 comprises a liquid container 2. The liquid container 2 can generally be a storing container for beverages and/or water that can be combined with further taste agents to make beverages. The liquid container 2 may comprise a tank or a similar vessel that can be filled with liquid such as water, coffee, tea, or other beverages. The beverage module 1 can also comprise a plurality of liquid containers 2. The liquid container 2 can comprise a temperature sensor 210 configured to measure the temperature of the liquid inside the container. There may further be a level sensor 212 configured to measure the level or amount of liquid present in the liquid container 2. Further, a spill sensor 214 may be present, either in or next to the liquid container 2. Additionally or alternatively, the spill sensor 214 may be placed elsewhere in the beverage module 1, such as near sensitive electronics. There may also be a plurality of spill sensors 214 placed around the beverage module 1. The spill sensor 214 is preferably configured to detect the presence of liquid and/or beverage outside expected areas. Expected areas refer to the liquid container, beverage cup, and any intermediate liquid holding areas. For example, electronics such as second processing component 6 and their surroundings would not be expected areas for liquid to be present at. Put differently, the spill sensor 214 is configured to detect any spills or undesirable presence of liquid within the beverage container 1 (including preferably on the top surface 46).

The data from all the sensors 210, 212, 214 may be received by the second processing component 6, which is adapted to control and manage the beverage module 1. For example, if the temperature sensor 210 records a temperature outside of an acceptable range (such as, for example, below 60° C. for warm beverages or above 15° C. for cold beverages), the second processing component 6 may stop beverage distribution. If liquid is detected in unexpected areas, the second processing component 6 may determine that immediate maintenance is needed and alert the mobile robot 100 and/or the server 200.

The liquid container 2 further comprises a dispenser port 216. The dispenser port 216 is configured to allow exit of liquid from the liquid container 2. The liquid can either be directly transferred to a beverage cup (in case the liquid in the liquid container comprises a pre-made beverage), or it can be directed towards further components of the beverage module (e.g. via a pump) to be further processed and made into a beverage (for example, water from the liquid container 2 can be used to make coffee or tea directly within the beverage module 1). The dispenser port 216 is preferably controlled by the second processing component 6. That is, the dispenser port 216 can be configured to dispense the beverage and/or liquid upon command from the second processing component 6.

The beverage module 1 further comprises a beverage dispenser 4. The beverage dispenser 4 can be configured to dispense a beverage to a beverage recipient. Preferably, the beverage dispenser 4 comprises some mobile parts configured to move with respect to the beverage module 1.

The beverage dispenser 4 preferably comprises a lifter assembly 40. The lifter assembly 40 can be configured to actuate beverage cup 42 from a position where it may receive liquid and/or beverage via the dispenser port 216, to one where the beverage recipient may retrieve it. The lifter assembly 40 can be configured to move translationally and/or rotationally, and linearly along one or preferably more axes. The lifter assembly 40 is preferably controlled via the second processing component. That is, the lifter assembly 40 can actuate between different positions when prompted to via the second processing component 6.

The beverage dispenser 4 preferably also comprises a cup assembly 44 configured to hold a plurality of beverage cups 42. The cups 42 may be stacked in one or more stacks. The cup assembly 44 is preferably configured to dispense the cups 42 one by one onto the lifter assembly 40. The cup assembly 44 may be configured to actuate to alternate between dispensing one or the other stack of cups 42. This can be done either when one stack is empty and/or when multiple cup sizes are offered for the beverages. The actuation of the cup assembly 44 can comprise, for example, a rotational motion. The cup assembly 44 is preferably controlled via the second processing component 6. In other words, the cup assembly 44 can be configured to dispense beverage cups 42 upon command from the second processing component 6.

The cup assembly 44 and the lifter assembly 40 may be arranged in such a way, that cups 42 released by the cup assembly 44 get deposited onto the lifter assembly 40 when it is in a neutral position. In this way, the lifter assembly 40 may be configured to alternate between three different positions: the neutral position where a cup 42 may be deposited onto it from the cup assembly 44, a filling position where the deposited cup 42 may be filled via the dispenser port 216, and a dispensing position where the cup 42 may be retrieved by the beverage recipient.

The beverage dispenser 4 further preferably comprises a top surface 46. The top surface 46 can serve to protect the insides of the beverage module 1 from unauthorized interference, while simultaneously serving as a beverage dispensing surface. The top surface 46 is preferably located under the lid 106 of the mobile robot 100. The top surface 46 preferably comprises a hatch 48 that can be substantially circular. The hatch 48 can be used as an egress point through which the lifter assembly 40 may lift the beverage cup 42. In other words, the dispensing position of the lifter assembly 40 preferably is arranged so that the beverage cup 42 protrudes through the hatch 48 above the top surface 46 and can be removed by the beverage recipient. The hatch 48 can preferably comprise an open and a closed position. The hatch 48 preferably stays in the closed position until actuated via a second processing component 6 to allow the lifter assembly 40 to lift the beverage cup 42 through it.

The beverage module 1 further preferably comprises a second processing component 6. The second processing component 6 can be configured to control and coordinate the operation of the beverage module 1. The second processing component 6 can be further configured to coordinate beverage dispensing with the mobile robot 100 and/or with a remote server 200. For example, before starting the beverage dispensing process, the second processing component 6 may wait for input from a first processing component 116 of the mobile robot 100 confirming that the mobile robot 100 is stationary, and that the lid 106 is open.

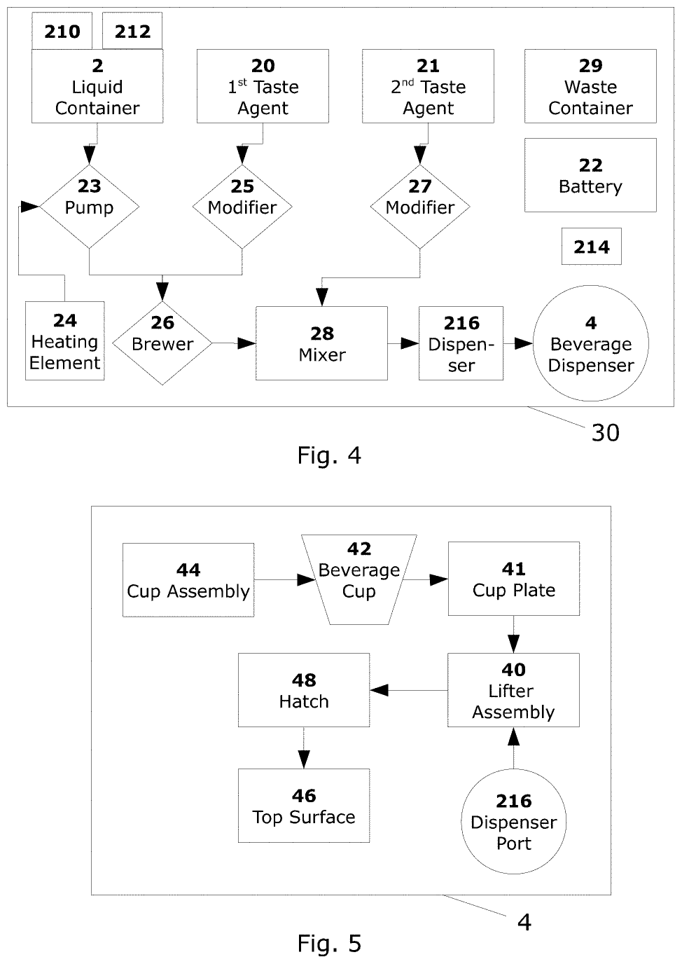

The second processing component 6 comprises a beverage control sub-process 60. The beverage control 60 can comprise controlling preparation and dispensing of a beverage. That is, the liquid container 2 and the beverage dispenser 4 can be controlled in a coordinated manner. If beverage preparation and/or brewing is required, the second processing component can also control this. Further details of an embodiment of beverage preparation are discussed below in the description to FIG. 4.

The second processing component 6 can also receive and process sensor inputs 62. That is, measurements taken by the temperature sensor 210, the level sensor 212, the spill sensor 214 and/or further sensors can be evaluated by the second processing component 6.

The sensor inputs 62 can be at least partially used for state control 64. The state control 64 may be monitoring the condition and/or health of the beverage module. That is, any detected spills may be identified as part of state control 64. Furthermore, unexpected behavior of the liquid container 2, the beverage dispenser 4 and/or further components can be identified as part of state control 64. The second processing component 6 can then alert the mobile robot 100 and/or the server 200 if the state of the beverage module has changed, so that, for example, maintenance, refilling and/or replacement can be requested.

The second processing component 6 preferably also comprises communication subroutines 66. That is, the second processing component 6 can exchange communication with the mobile robot 100 via its first processing component 116 and/or with the server 200. Instructions, commands and/or status reports can be sent and received via this communication.

The beverage module 1 further preferably comprises a second communication component 8. The second communication component 8 can be integrated with the processing component 6 (e.g. as part of a system on a chip device or board). Additionally or alternatively, the second communication component 8 can be a standalone device. The second communication component 8 can comprise a plurality of communication protocols that can be used either as failsafes and/or to communicate with different other members of the beverage dispensing system.

The second communication component 8 can communicate via the WLAN protocol 80. This can be useful, for example, when the mobile robot 100 is stationed at a hub 400, which may have its own WLAN network. Communication via cellular networks 82 such as GSM, CDMA can also be desired. This can be used, for example, when the mobile robot 100 is travelling to a dispensing location and the beverage module 1 communicates with a server 200 (and/or the mobile robot 100).

For more local communication, particularly between the beverage module 1 and the mobile robot 100, the communication component 8 can comprise Bluetooth® 84, NFC 86 and/or infrared 88 communication modules. For instance, Bluetooth Low Energy (BLE) can be used to communicate between the beverage module 1 and the mobile robot 100 to reduce energy usage.

FIG. 4 schematically depicts an embodiment of an optional beverage preparation component 30. If present, such a component is generally manufactured between the liquid container 2 and the dispenser port 216. That is, liquid from the liquid container 2 would not directly go to the dispenser port 216 to be dispensed to a beverage cup 42, but would first pass through a series of other components in order to prepare a beverage. The figure schematically shows the flow of liquid and other beverage ingredients starting from the liquid container 2 until the dispenser port 216.

The liquid from the liquid container 2 (which preferably comprises water) is pumped via a pump 23 while being heated by a heating element 24. The liquid may then be combined with a first taste agent 20 in a brewer 26. The first taste agent 20 may first pass through a modifier 25. For example, the first taste agent 20 may comprise coffee beans that are ground in a modifier (grinder) 25. The first taste agent 20 may also comprise powdered coffee and/or powdered hot chocolate, so that no modifier 25 is needed nor present.

After the brewer 26, the mixture proceeds to a mixer 28, where it may be mixed with a second taste agent 21 that has been passed through a second modifier 27. In a concrete example, the second taste agent 21 may comprise milk, which can get frothed in the second modifier (milk frother) 27. Additionally or alternatively, the second taste agent 21 may comprise sugar, which may not need modifying, and the second modifier 27 would not be present in this case.

After the mixing in the mixer 28, the resulting beverage is directed to the dispenser port 216, from which it is released to the beverage dispenser 4.

The beverage preparation component 30 may further comprise a waste container 29, where any waste generated during the preparation of the beverage may be disposed (for example, used coffee grounds may be disposed there).

Furthermore, a battery 22 may be present in case active heating is needed as part of beverage preparation. Alternatively, the liquid in the liquid container 2 may be brought to the desired temperature and insulated sufficiently, so that neither the battery 22 nor the heating element 24 are needed. In this case, there may be an insulating layer and/or a plurality of insulating layers around the liquid container 2.

FIG. 5 schematically depicts exemplary components and configuration of the beverage dispenser 4. Cup assembly 44 dispenses a beverage cup 42 onto a cup plate 41 of the lifter assembly 40. As described above, the cup assembly may be configured to hold one or a plurality of stacks of beverage cups 42, and to actuate as needed to change between stacks. The cup plate 41 of the lifter assembly 40 may comprise a sufficiently flat surface, preferably with an indentation or a further means of stabilizing the cup 42. The lifter assembly 40 is preferably configured to actuate in a filing position, where beverage from the dispenser port 216 may enter the cup 42. The cup 42 with the beverage can then be transported by the lifter assembly 40 towards the hatch 48. The hatch 48 can open to allow the lifter assembly 40 to raise the beverage cup 42 through the opening and past the top surface 46. The beverage cup may then be retrieved by the beverage recipient.

In an alternative embodiment, the recipient may wish to use their own, reusable cup for beverage dispensing. In this case, the lifter assembly 40 can be configured to raise the cup plate 41 towards the hatch 48, which can move into an open position. The recipient can then place their cup on the cup plate 41 of the lifter assembly 40. The lifter assembly 40 can detect the presence of the cup (e.g. via weight and/or further sensors) and move the recipient's cup to the filling position. There, the recipient's cup may be filled with the beverage via the dispensing port 216, and it can be returned to the dispensing position through the hatch 48 (which can either remain open, or, preferably, close after the recipient's cup has been lowered into the beverage module.

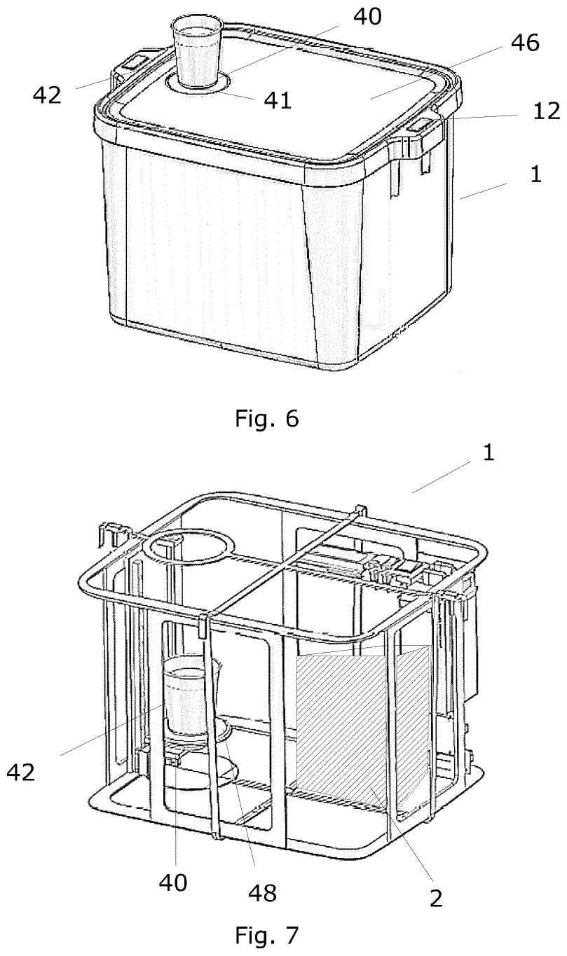

FIGS. 6 and 7 depict the beverage module 1 without the mobile robot 100. FIG. 6 shows a similar view to FIG. 1: a beverage cup 42 is shown on the lifting assembly 40, with the cup plate 41 of the lifting assembly 40 vertically displaced with respect to the top surface 46. Also shown is the securing component 12 that can be used to fix the beverage module 1 to the mobile robot 100.

FIG. 7 shows a view of the beverage module 1 with transparent walls. The lifting assembly 40 is shown in a lowered position, with rails on the right side of the beverage module 1 facilitating vertical displacement. Also shown is the liquid container 2, schematically depicted as a tank that can contain liquid such as water and/or a pre-made beverage. Multiple liquid containers 2 can be present within the beverage module 1.

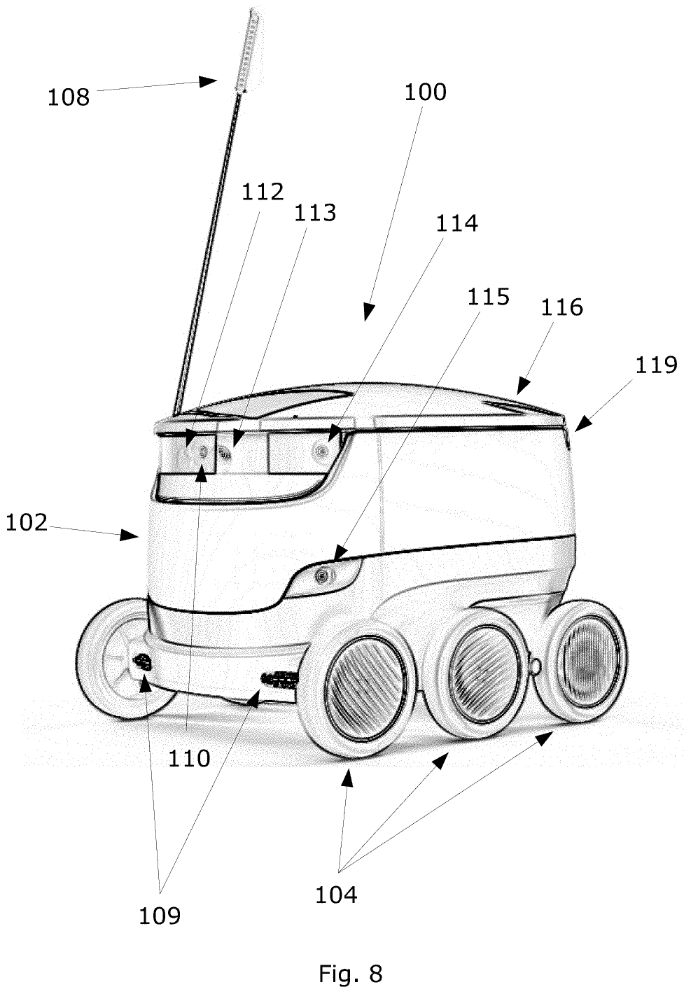

FIG. 8 demonstrates an exemplary embodiment of the mobile robot 100. The mobile robot 100 can comprise a delivery or a vending robot, that is, it can transport and deliver packages, consumable items, groceries or other items to customers. Preferably, the mobile robot 100 is outfitted with a beverage module (not shown in the figure).

The mobile robot 100 comprises a robot body 102. The body 102 comprises an item compartment in which items can be placed and transported by the robot (not shown in the present figure).

The mobile robot 100 further comprises a motion component 104 (depicted as wheels 104). In the present embodiment, the motion component 104 comprises six wheels 104. This can be particularly advantageous for the mobile robot 100 when traversing curbstones or other similar obstacles on the way to delivery recipients.

The mobile robot 100 comprises a lid 106. The lid 106 can be placed over the item compartment and locked to prevent unauthorized access to the beverage module.

The mobile robot 100 further comprises a robot signaling device 108, depicted here as a flagpole or stick 108 used to increase the visibility of the robot 100. Particularly, the visibility of the robot 100 during road crossings can be increased. In some embodiments, the signaling device 108 can comprise an antenna. The mobile robot 100 further comprises robot headlights 109 configured to facilitate the robot's navigation in reduced natural light scenarios and/or increase the robot's visibility further. The headlights are schematically depicted as two symmetric lights 109, but can comprise one light, a plurality of lights arranged differently and other similar arrangements.

The mobile robot 100 also comprises robot sensors 110, 112, 113, 114, 115, and 119. The sensors are depicted as visual cameras in the figure, but can also comprise radar sensors, ultrasonic sensors, Lidar sensors, time of flight cameras and/or other sensors. Further sensors can also be present on the mobile robot 100. One sensor can comprise a front camera 110. The front camera 110 can be generally forward facing. The sensors may also comprise front, side and/or back stereo cameras 112, 113, 114, 115, 119. The front stereo cameras 112 and 113 can be slightly downward facing. The side stereo cameras 114 and 115 can be forward-sideways facing. There can be analogous side stereo cameras on the other side of the robot (not shown in the figure). The back stereo camera 119 can be generally backward facing. The sensors present on multiple sides of the robot can contribute to its situational awareness. That is, the robot 100 can be configured to detect approaching objects and/or hazardous moving objects from a plurality of sides and act accordingly.

The robot sensors can also allow the robot 100 to navigate and travel to its destinations at least partially autonomously. That is, the robot can be configured to map its surroundings, localize itself on such a map and navigate towards different destinations using in part the input received from the multiple sensors.

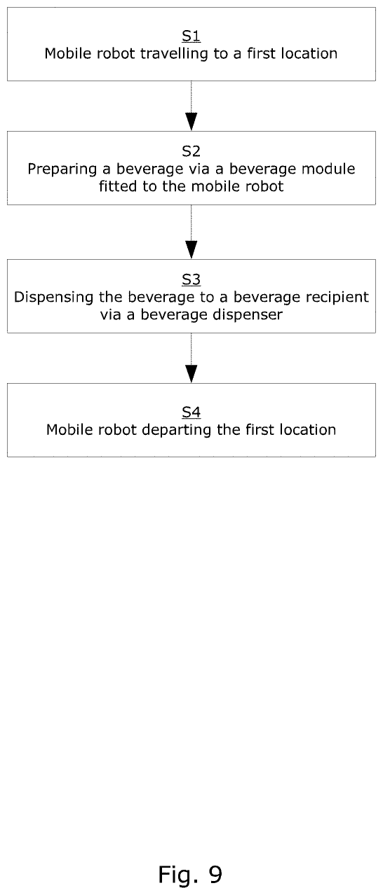

FIG. 9 depicts an exemplary embodiment of a method for beverage dispensing using the system described in the present disclosure. In step S1, the mobile robot 100 may travel to a first location. This can be in response to a request for a beverage via a user terminal 300, or the first location may be a pre-planned dispensing location.

In step S2, a beverage is prepared via the beverage module 1. Note, that preparing may refer to actually mixing ingredients and effecting physical changes on them (such as heating and/or grinding), or it can refer to simply dispensing a beverage from the liquid container 2 to the beverage cup 42 in case a pre-made beverage is available.

In step S3, the beverage is dispensed to a beverage recipient via a beverage dispenser 4. Note, that the beverage recipient may or may not be a user that requests a beverage via the user interface (e.g. someone may order a cup of coffee for a friend).

Step S4 comprises the mobile robot 100 departing the first location upon dispensing the beverage. The mobile robot may then navigate to a further dispensing location, proceed to roam according to a pre-planned route and/or instructions from a remote server 200, and/or depart to a hub 400 in case maintenance, refilling and/or servicing is needed (either for the mobile robot 100 and/or for the beverage module 1).

### LIST OF REFERENCE NUMERALS

### Beverage Module Components

1—beverage module
2—liquid container
20—first taste agent
21—second taste agent
210—temperature sensor
212—level sensor
214—spill sensor
216—dispenser port
22—battery
23—pump
24—heating element
25—first modifier (grinder)
26—brewer
27—second modifier (steamer)
28—mixer
29—waste container
4—beverage dispenser
40—lifter assembly
41—cup plate
42—beverage cup
44—cup assembly
46—top surface
48—hatch
6—second processing component
8—second communication component
12—securing component

### Mobile Robot Components

100—mobile robot
102—robot body
104—motion component
106—lid
108—signalling device
109—headlights
110—front camera
112—front stereo camera
113—front stereo camera
114—side stereo camera
115—side stereo camera
116—first processing component
118—first communication component
119—back stereo camera

### Further System Components

200—server
300—user interface
400—hub

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-30. (canceled)

31. A beverage dispensing system comprising:
a mobile robot comprising a motion component, a first processing component, and a first communication component; and
a beverage module fitted to the mobile robot and comprising at least one liquid container, at least one beverage dispenser, a second processing component, and a second communication component.

32. The system according to claim 31, wherein the mobile robot has a body, and wherein the beverage module is removably fitted to an opening within the body of the mobile robot.

33. The system according to claim 31, wherein the mobile robot further comprises a lockable lid arranged so as to prevent access to the beverage module in a closed position and allow access to at least part of the beverage module in an open position.

34. The system according to claim 31, wherein
the first communication component and the second communication component are configured to communicate with each other, and
the first communication component and the second communication component are configured to exchange data related to preparing a beverage and dispensing it to a beverage recipient, and
the first processing component and the second processing component are configured to coordinate providing a beverage to the beverage recipient via the first communication component and the second communication component.

35. The system according to claim 31, further comprising at least one inclination sensor, and wherein
prior to dispensing a beverage via the beverage module, at least one of the first processing component and/or the second processing component determines an inclination of the mobile robot based on data from the inclination sensor, and
the second processing component is configured to abort beverage dispensing if the mobile robot's inclination is not within a predetermined range.

36. The system according to claim 35, wherein the motion component of the mobile robot is further configured to adopt a compensating position if the mobile robot's inclination is determined to not be within a predetermined range.

37. The system according to claim 31, wherein the beverage module further comprises at least one spill sensor configured to detect liquid outside expected areas of the beverage module.

38. The system according to claim 31, further comprising a server configured to communicate with the first and second communication components.

39. The system according to claim 38, wherein the server is configured to receive a status of the beverage module and direct the mobile robot to navigate to a predetermined location based on the status and wherein the status of the beverage module comprises at least one of:
low beverage levels; and/or
maintenance required; and/or
spill detected; and/or
low battery level; and/or
temperature of beverage outside predetermined levels.

40. The system according to claim 39 wherein the system further comprises a hub configured to at least one of:
refill the beverage module with liquid; and/or
service the beverage module; and/or
maintain the beverage module, and
wherein the predetermined location comprises the hub.

41. The system according to claim 38 further comprising a user interface configured for communicating with the server, and
wherein the user interface is configured for receiving requests for a beverage at a user-specified location.

42. The system according to claim 41, wherein
the server is further configured to determine whether inclination data is available for the user-specified location and to verify that said inclination data is within a predefined range, and
the server is further configured to suggest an alternative location if an inclination at the user-specified location is not within a predetermined range.

43. A method for dispensing beverages, the method comprising:
a mobile robot comprising a motion component, a first processing component and a robot communication component travelling to a first location by using the motion component;
at the first location, preparing a beverage via a beverage module fitted to the mobile robot and comprising at least one liquid container, at least one beverage dispenser, a second processing component, and a second communication component;
dispensing the beverage to a beverage recipient via the beverage dispenser; and
the mobile robot departing the first location.

44. The method according to claim 43 wherein the mobile robot further comprises a lockable lid arranged so as to prevent access to the beverage module in a closed position and allow access to at least part of the beverage module in an open position, and wherein the method further comprises:
the first processing component causing the lid to change from the closed position to the open position before communicating to the second processing component via the first and second communication components that the beverage can be distributed to the beverage recipient.

45. The method according to claim 43 further comprising, prior to dispensing a beverage via the beverage module,
measuring the mobile robot's inclination based on data from an inclination sensor; and
aborting beverage dispensing if the measured inclination does not fall within a predetermined range.

46. The method according to claim 45 further comprising the mobile robot adopting a compensating position if the mobile robot's inclination is determined to be outside a predetermined range.

47. The method according to claim 43 further comprising a server communicating with the first and second communication components.

48. The method according to claim 47 further comprising the server directing the mobile robot to roam a target area and wherein the target area is identified as likely having a plurality of beverage recipients interested in receiving a beverage via the beverage module.

49. The method according to claim 47, further comprising the server directing the mobile robot to a hub for at least one of:
(i) refilling the beverage module with liquid; and/or
(ii) servicing the beverage module; and/or
(iii) maintaining the beverage module,
upon receiving data indicative of the beverage module requiring at least one of (i) and/or (ii) and/or (iii).

50. The method according to claim 43, further comprising, prior to the mobile robot travelling to the first location,
receiving a beverage request to the first location from a user via a user interface;
receiving at least one beverage parameter from a user via a user interface; and
preparing a beverage with the at least one beverage parameter.
